(19) United States
(12) Patent Application Publication
(10) Pub. No.: US 2005/0183672 A1
(43) Pub. Date: Aug. 25, 2005

(54) Cat litter box

(76) Inventor: Ronald Anthony Lewis II, St. Louis, MO (US)

Correspondence Address: BELL, BOYD & LLOYD, LLC, PO BOX 1135, CHICAGO, IL, 60690-1135, US

(21) Appl. No.: 11/118,892

(22) Filed: Apr. 28, 2005

Related U.S. Application Data
(63) Continuation of application No. 10/976,052, filed on Oct. 27, 2004.
(60) Provisional application No. 60/518,477, filed on Nov. 6, 2003.

(51) Int. Cl. A01K 29/00

(52) U.S. Cl. 119/165

(57) ABSTRACT

A pet litter box including a body defined by a top portion and a bottom portion, the top portion including a portion that is hingedly connected to other portions of the litter box to allow at least a portion thereof to be pivoted away from other portions of the body, the top including an opening for allowing a pet to enter an interior defined by the body of the cat litter box is provided.

### PRIORITY CLAIM

This application is a continuation of U.S. patent application Ser. No. 10/976,052, filed Oct. 27, 2004, which claims the benefit of U.S. Provisional Patent Application No. 60/518,477, filed Nov. 6, 2003, the disclosures of which are hereby incorporated by reference.

### BACKGROUND OF THE INVENTION

The present invention relates to pets and pet care. More specifically, the present invention relates to cat litter boxes.

### SUMMARY OF THE INVENTION

The present invention relates to new and improved designs for pet litter boxes. The design and structure of the pet litter box provides many useful features to the pet owner. Although the pet litter box is in a preferred embodiment designed for cats, it should be appreciated that it can be designed for use with other pets.

Generally, the pet litter box has a top and a bottom component. The top component preferably includes a hingeable portion with an opening for the cat to enter and exit.

In an embodiment, the present invention provides a pet litter box comprising a body defined by a top portion and a bottom portion, the top portion including a portion that is hingedly connected to other portions of the body of the litter box to allow at least a portion thereof to be pivoted away from other portions of the body, the top including an opening for allowing a pet to enter an interior defined by the body of the cat litter box.

In an embodiment, the present invention provides a pet litter box wherein the litter box is designed for a cat.

In an embodiment, the present invention provides a pet litter box wherein the opening is in the shape of a cat face.

In an embodiment, the present invention provides a pet litter box wherein the top portion can be stored inside the bottom portion in a nestable fashion.

In an embodiment, the present invention provides a pet litter box wherein the interior is defined in part by a bottom portion and the bottom portion includes at least eight textured portions.

In an embodiment, the present invention provides a pet litter box wherein an outer portion of the litter box includes a handle.

In an embodiment, the present invention provides a pet litter box including at least one side vent and a charcoal vent.

In an embodiment, the present invention provides a pet litter box including a friction snap to allow the portion that is hingedly connected to be removably secured to remaining portions of the body.

In an embodiment, the present invention provides a cat litter box having a plastic body including a top and a bottom, the top and the bottom defining an interior therein including a bottom portion for receiving cat litter, at least a portion of the top of the body being hingedly connected to other portions of the body to allow a portion thereof to pivot, the pivoting portion including an opening for allowing a cat to enter and exit the pet litter box, and the cat litter box including at least one side vent and charcoal vent.

In an embodiment, the present invention provides a pet litter box wherein the opening is in the shape of a cat face.

In an embodiment, the present invention provides a pet litter box wherein the top portion can be stored inside the bottom portion in a nestable fashion.

In an embodiment, the present invention provides a pet litter box wherein the interior is defined in part by a bottom portion and the bottom portion includes at least eight textured portions.

In an embodiment, the present invention provides a pet litter box including a friction snap to allow the portion that is hingedly connected to be removably secured to remaining portions of the body.

An advantage of the present invention is to provide an improved cat litter box.

Still further, an advantage of the present invention is to provide an improved design for a cat litter box.

Another advantage of the present invention is to provide an improved plastic cat litter box.

Still, an advantage of the present invention is to provide a cat litter box that has a fanciful design, such as an opening in the shape of a cat's face.

Furthermore, an advantage of the present invention is to provide a cat litter box that is nestable with other cat litter boxes allowing the products to easily be stored at a retailer.

Additional features and advantages of the present invention are described in, and will be apparent from, the following Detailed Description of the Invention and the figures.

### BRIEF DESCRIPTION OF THE FIGURES

FIG. 1 illustrates various views of an embodiment of the cat litter box of the present invention and specifically an assembly of same.

FIG. 2 illustrates bottom views of the cat litter box of FIG. 1.

FIG. 3 illustrates views of an embodiment of the lid of the cat litter box of FIG. 1.

FIG. 4 illustrates an embodiment of the top of the cat litter box of FIG. 1.

FIG. 5 illustrates as A through F embodiments of the opening of the cat litter box of the present invention.

FIG. 6 illustrates as A through F embodiments of the handle for the cat litter box of the present invention.

FIG. 7 illustrates as A through F embodiments of vents for the cat litter box of the present invention.

### DETAILED DESCRIPTION OF THE INVENTION

The present invention provides improved pet and cat litter boxes. Of course, it is known in the art to provide litter boxes so as to allow a sanitary area for a cat, or other small pet, to urinate and/or defecate. These litter boxes provide a structure in which to house cat litter or other absorbent material for receiving the pet waste.

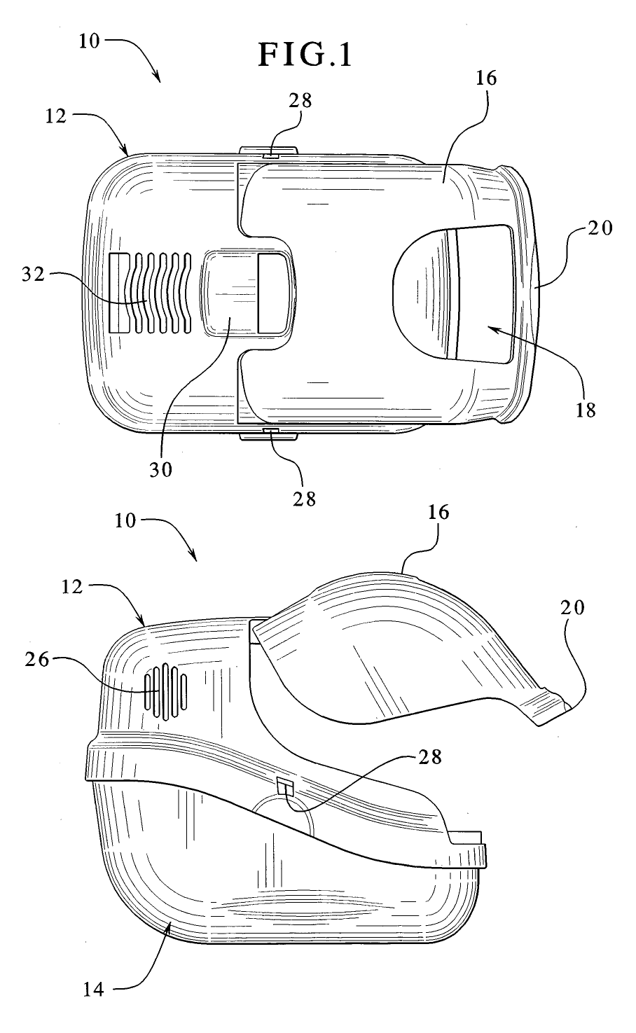

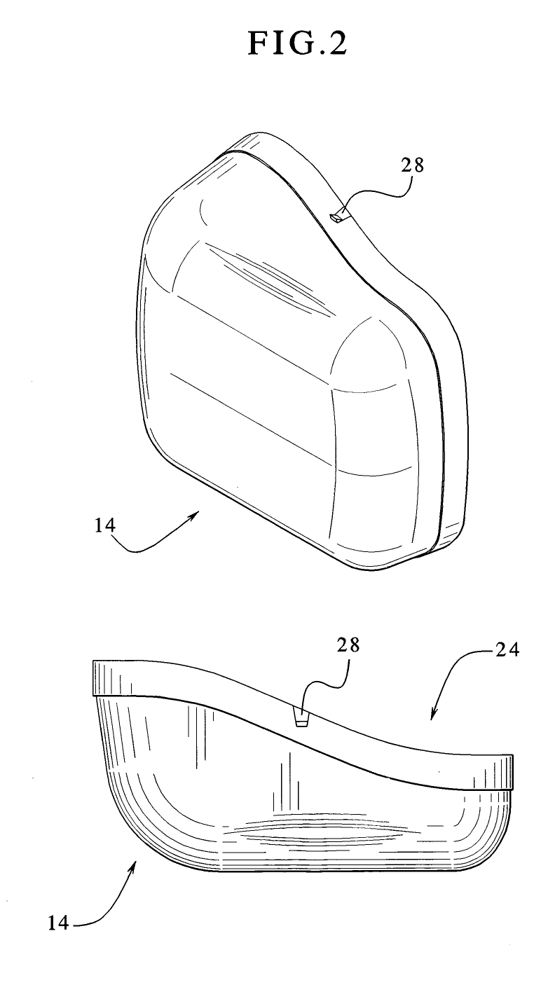

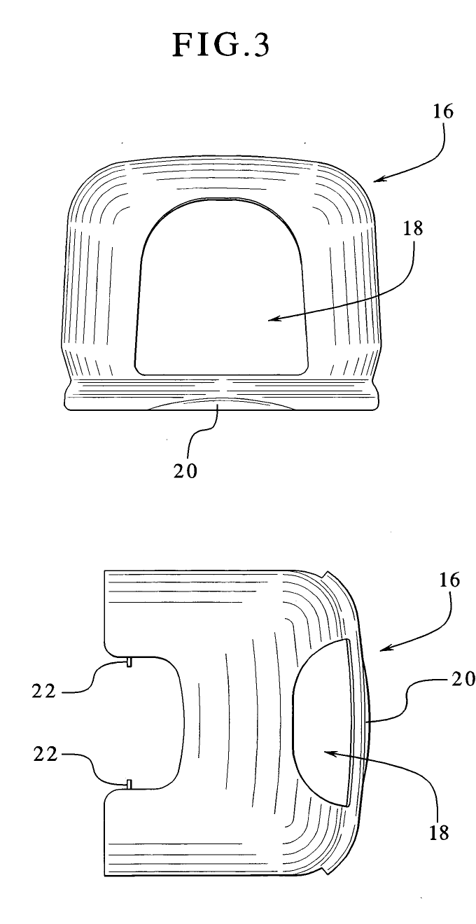

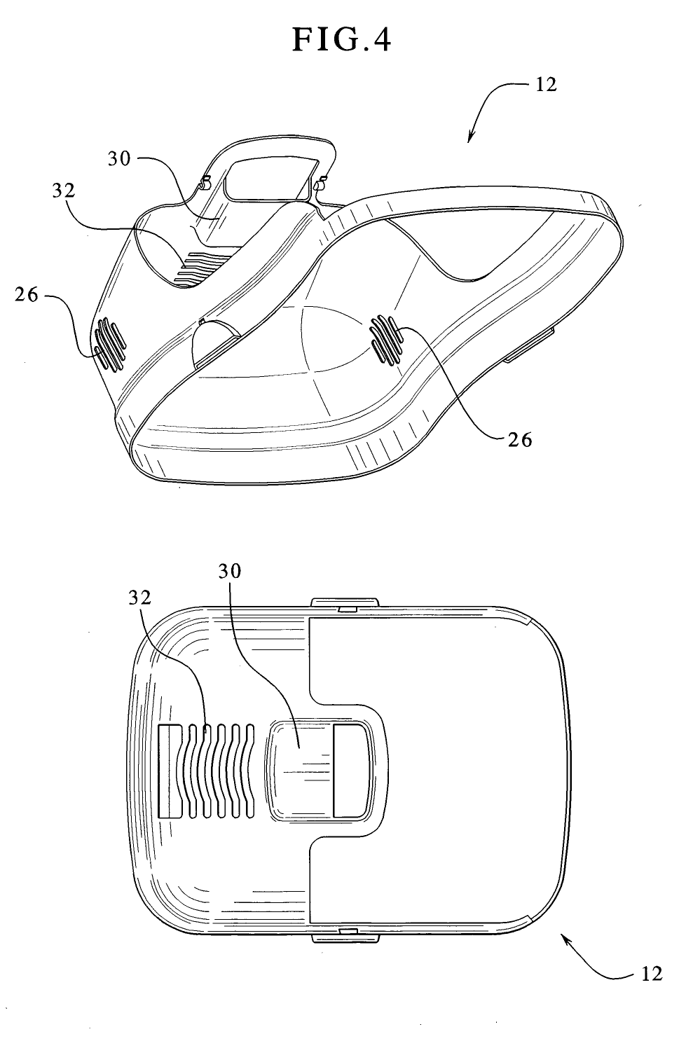

As set forth in FIGS. 1-7, various designs and embodiments of the cat litter box 10 of the present invention are provided. Generally, as illustrated in FIG. 1, the cat litter box has a top 12 and a bottom component 14. The top component 12 further includes a part that is hinged. The hinged portion 16 allows one access to an interior of the cat litter box 10. In the illustrated embodiments, the hinged top portion 16 includes an opening 18 for the cat, or other pet, to enter and exit.

Preferably, the litter box is nestable. To this end, the top 12, when not in use, can be inserted into the bottom 14. This allows multiple litter boxes to be stacked on top of one another. The nestable feature provides a compact design for the retailer in stocking/dispensing the litter boxes to customers.

Preferably, the front of the litter box 10 has a friction snap 20 to lock the top to the bottom. Thus, the pet can enter and exit the litter box 10 without the top portion opening. The top 12 of the litter box 10 is hinged to the remaining portions by, preferably, at least two hinges 22 to allow it to swing up.

The litter box 10 defines an interior for receiving the cat litter. This interior includes a bottom portion 24 on which the cat litter is located. Preferably, the bottom 24 of the cat litter box 10 is textured. Preferably, there are a minimum of eight types of textured bottoms to prevent the cat litter from sticking to the bottom of the container.

If desired, the bottom portion 24 of the cat litter box 10 can include a disposable liner (not shown). Also, in an embodiment, the inside bottom texture is chosen to reduce the cat litter from sticking to the bottom of the container which makes it easier to clean and to remove clumped cat litter. Preferably, the shape of the bottom piece has a waste and is not square or oblong.

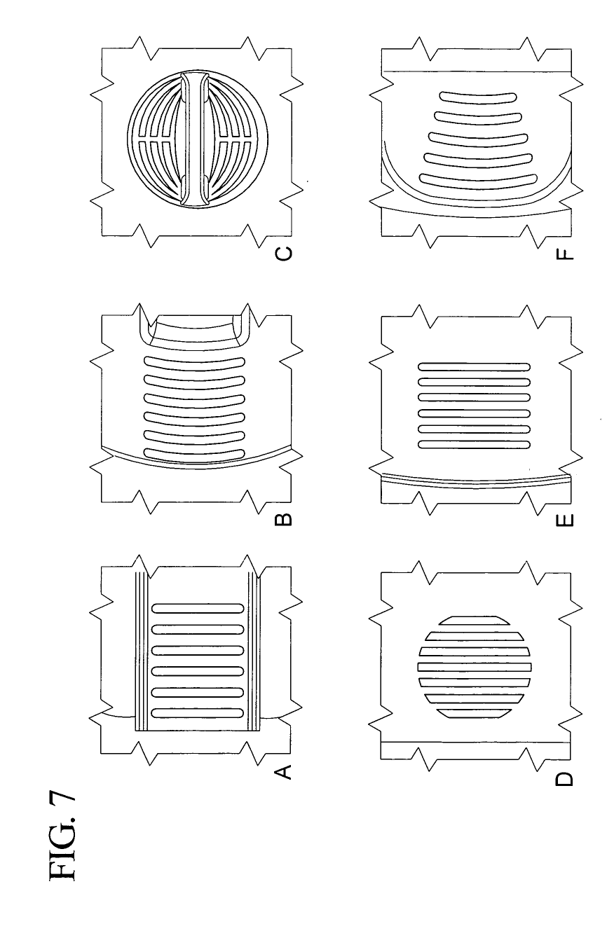

To reduce smell within the cat litter box 10, side vents 26 are provided. The side vents 26 increase the air flow within and through the interior. Moreover, by being placed on the side they prevent cat litter from being kicked out by the cat. A variety of vents can be provided as illustrated in FIG. 7 as A through F.

In order to ensure that the top portion 12 of the cat litter box 10 is coupled to the bottom portion 14, side locks 28 are provided in a preferred embodiment. The side locks 28 are preferably pressure side locks to removably lock or secure the top to the bottom.

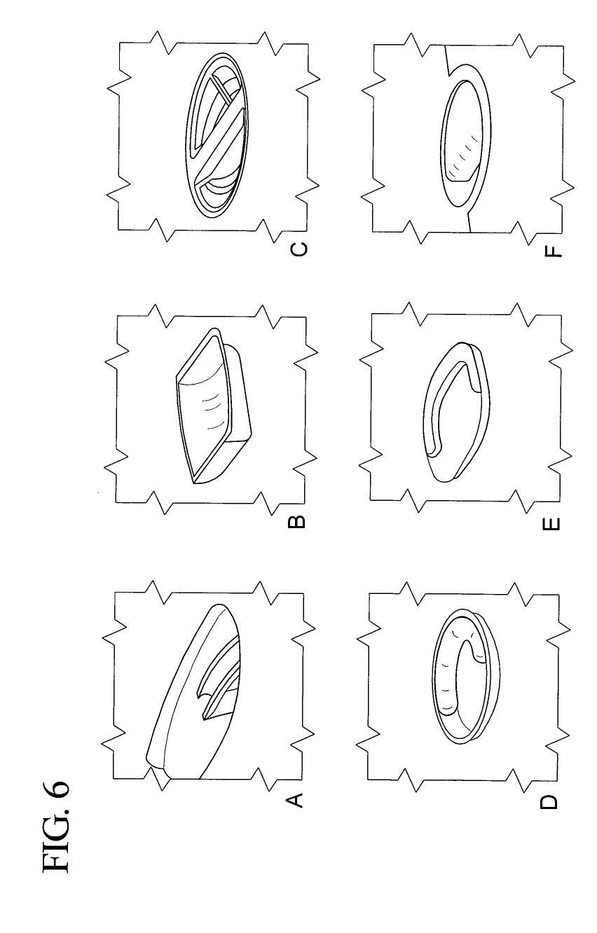

In order to allow the cat litter box 10 to be easily transported, preferably a handle 30 is located on the top of the litter box. The handle 30 is used to carry the litter box. Preferably, the handle 30 is molded to fit four fingers. In an embodiment, the handle 30 is molded to encompass a finger grip. FIG. 6 illustrates a number of embodiments of the handle.

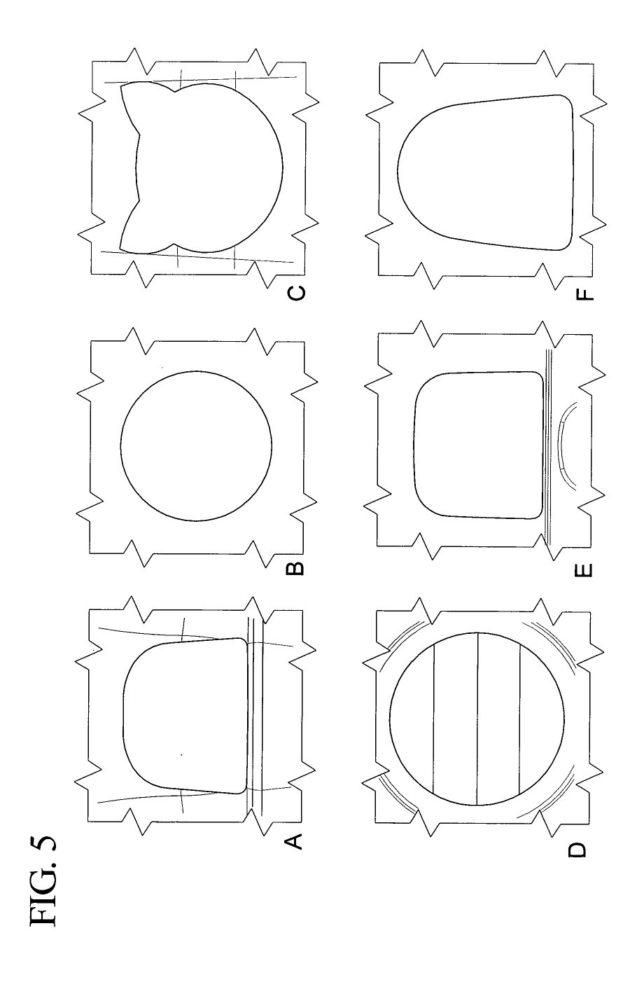

The opening 18 of the cat litter box 10 is designed to allow the cat, or other pet, to be able to enter the litter box. A variety of different openings can be utilized. FIG. 5 illustrates six embodiments of the opening A, B, C, D, E and F. For example, FIG. 5C illustrates the shape of a cat's face as the opening to the cat box.

Preferably, located at the top of the litter box 10 is a charcoal vent 32. The combination of the side vents 26 and the front opening 18 allow more efficient air flow for the charcoal. This is believed to result in a longer-lasting charcoal filter. In this regard, it is believed that the charcoal filter will only have to be replaced every month or two.

By way of example and not limitation, the structure of the cat litter box can be as follows:
Top and bottom made of Polypropylene Plastic
Front portion top made of Clarified Polypropylene Plastic
Front Portion Hinged at 50% of the top of the Cat Box
Pressure Front Locks on the Hinged portion of the Top of the Cat Box.
2 Pressure Side Locks
Tunnel Opening:
Dimensions: 7″×7″
Rectangular Shape:
Dimension 20″×15″×16″
Litter Box Thickness:
0.08″
Recessed Handle with indentions for finger grips
4″×6″ Charcoal Filter vent in the top back portion of the Cat Box—Odor Control
6—Vent slots in a Sinusoidal Wave Pattern
3″×3″ Side Vents on either side of the top portion of the Cat Box
5—slots on each vent—Increase Air Circulation to make the Charcoal Filter more efficient.
Both Sides of the bottom of the Cat Litter box are curved in ½″
Exterior Texture
Pebble Pattern AMT-9330 or 9225
Embossed Logo and lettering slick Smooth Surface AMT-9485 0.0005″ Deep
Interior of Bottom Textured:
Plaid Pattern AMT-9220 0.003″ Deep or Slick, Smooth Surface AMT-9485 0.0005″ Deep
Anti-microbial Agent from Microban.

If desired, the cat litter box can also include the following features:
Top and bottom made of Polystyrene, Polyester, Polyethylene Plastic or Clarified Polypropylene
Front portion top made of Styrene, Polyethylene, or Polypropylene Plastic
Front Portion Hinged at front, back or clam shell of the top of the Cat Box
No Pressure locks on the hinged portion.
2-4 Pressure Side Locks/Front Pressure locks
Round, Oval, Cat Face, Cat's Tail End, etc. Opening:
Dimensions: 6″-10″ in height and 6″-10″ in Width
Round, Octagon, Hexagonal Shape:
Dimension 14″-24″ in Length, 14″-24″ in Width×14″-24″ in Height
Litter Box Thickness:
0.03″-0.15″
Recessed Handle with indentions for finger grips
Charcoal Filter vent in the top back portion of the Cat Box: 3″-8″ in Width and 3″-10″ in Length
3-10 Vent slots in a Sinusoidal Wave Pattern, straight, curved, zigzag, etc.
Side Vents on either side of the top portion of the Cat Box: 1″-6″ Length and 1″-6″ in Width
2-8 slots on each vent at an 1-180 Degree angle
Both Sides of the bottom of the Cat Litter box are curved in ⅛″-3″
Exterior Texture
Pebble Pattern AMT-9330 or 9225
Embossed Logo and lettering slick Smooth Surface AMT-9485 0.0005″ Deep
Interior of Bottom Textured:
Plaid Pattern AMT-9220 0.003″ Deep or Slick, Smooth Surface AMT-9485 0.0005″ Deep
Anti-microbial Agent supplied by Microban or Aglon
Anti-Sticking Agents like Teflon, Silicone, and Polydimethyl Siloxane
Anti-Staining Agents like Silicone and Polycarbonate
Biodegradable Agents like polyhydroxybutyrate (PHB)
Litter Mat Accessory
Specifically Designed Liner.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A pet litter box comprising:
a body including a first portion connected to a second portion wherein said first and second portions define an interior, said body defining an opening that allows a pet to enter and exit the interior of said body, said body including at least one vent.

2. The pet litter box of claim 1, wherein said vent is a charcoal vent.

3. The pet litter box of claim 1, wherein the body includes a plurality of vents.

4. The pet litter box of claim 3, wherein one of said vents is a charcoal vent.

5. The pet litter box of claim 1, wherein the top of the body includes a vent having a filter.

6. The pet litter box of claim 5, wherein the filter is a charcoal filter.

7. The pet litter box of claim 1, wherein the body includes a handle.

8. The pet letter box of claim 7, wherein the handle is a recessed handle with indentations for finger grips.

9. The pet litter box of claim 7, wherein the handle is hingedly connected to the body.

10. The pet litter box of claim 1, including at least one friction snap to allow the first portion to be removably secured to the second portion of said body.

11. The pet litter box of claim 1, wherein the first portion can be stored inside the second portion in a nestable fashion.

12. The pet litter box of claim 1, wherein the first and second portions are hingedly connected.

13. A cat litter box comprising:
a plastic body defining an interior including a top portion and a bottom portion, wherein said bottom portion is adapted to receive cat litter, at least one of said top and bottom portions defining an opening for allowing a cat to enter and exit the interior of the body, said body including at least one vent.

14. The cat litter box of claim 13, wherein said body includes a pivoting portion hingedly connected to another portion of said body to allow said pivoting portion to pivot.

15. The cat litter box of claim 14, which includes at least one friction snap to allow the pivoting portion to be removably secured to said at least one other portion of said body.

16. The cat litter box of claim 13, wherein the top of said body includes a vent having a filter.

17. The cat litter box of claim 16, wherein the filter is a charcoal filter.

18. The cat litter box of claim 13, wherein the body includes a handle.

19. The cat letter box of claim 18, wherein the handle is a recessed handle with indentations for finger grips.

20. The pet litter box of claim 18, wherein the handle is hingedly connected to the body.

21. The cat litter box of claim 13, wherein the bottom portion of the interior includes a disposable liner.

22. The cat litter box of claim 13, wherein the bottom portion of the interior includes at least eight textured portions.

23. The cat litter box of claim 13, wherein the body is constructed from a material selected from the group consisting of: Polystyrene, Polyester, Polyethylene, Polyethylene Plastic, Clarified Polypropylene and Styrene.

24. The cat litter box of claim 13, wherein the top portion can be stored inside the bottom portion in a nestable fashion.

25. The cat litter box of claim 13, wherein the top and bottom portions are hingedly connected.

26. A pet litter box comprising:
a body defining an interior, said body including a top component connected to a bottom component; and
a door hingedly connected to said top component to enable the door to pivot, said door defining an opening which allows a pet to enter and exit the interior of said body.

27. The pet litter box of claim 26, which includes a filter attached to said top component.

28. The pet litter box of claim 27, wherein the filter is a charcoal filter.

29. The pet litter box of claim 26, wherein the body includes at least one side vent.

30. The pet litter box of claim 26, wherein the top component includes a handle.

31. The pet litter box of claim 30, wherein the handle is hingedly connected to the top component.

32. The pet litter box of claim 26, wherein the top component can be stored inside the bottom component in a nestable fashion.

33. The pet litter box of claim 26, wherein the top component and the bottom component are hingedly connected.
